(19) United States
(12) Patent Application Publication
(10) Pub. No.: US 2010/0242849 A1
(43) Pub. Date: Sep. 30, 2010

(54) PET BEDDING

(76) Inventors: Brent Alexander Newton, Houston, TX (US); Tasia Michelle Newton, Houston, TX (US)

Correspondence Address: ADAM K. SACHAROFF;MUCH SHELIST DENENBERG AMENT & RUBENSTEIN, 191 N. WACKER DRIVE, Suite 1800, CHICAGO, IL, 60606-1615, US

(21) Appl. No.: 12/415,591

(22) Filed: Mar. 31, 2009

(51) Int. Cl. A01K 29/00

(52) U.S. Cl. 119/172; 119/171

(57) ABSTRACT

A pet bedding designed to allow for easy and convenient clean-up of animal excreta. It is biodegradable and designed with the dimensions of corresponding pet cages found in pet shops. The design consists of two layers of white cotton cloth filled with wood pulp. The top layer of cloth is perforated with evenly-spaced, holes. The top layer of cloth is sewn to the bottom layer using cotton thread. This product is useful because it eliminates the intense physical labor associated with replacing traditional loose pet bedding.

### FIELD OF THE INVENTION

The present invention relates generally to pet bedding used in cages to treat pet excreta,

### BACKGROUND OF THE INVENTION

The field of endeavor to which this invention pertains is pet bedding. Pet bedding products usually consist of loose wood pulp, cedar, or pine shavings. When loose pet bedding becomes dirty in a pet cage, substantial physical labor is required to remove the dirty bedding and to clean the cage floor. Cage liners may be placed beneath loose bedding to keep a pet cage floor clean and dry, but this provides an added expense to the pet owner. As a result, there is a need to provide a convenient alternative way to replace dirty bedding in an animal cage that is easy and convenient. The concept can also be “green,” with all of its materials being made from naturally grown fibers.

### SUMMARY OF THE INVENTION

The present invention in one embodiment is directed to pet bedding which is made with 100% cotton cloth. The bedding is made from a single sheet of material that has a first folded edge. Two side edges are stitched together to form an inside pocket for which the bedding material can be stuffed. The bedding material can be wood pulp and stuffed to a thickness of about 1 inch. Lastly, the edge opposite the folded edge can be stitched together in order to seal the bedding Inside the pocket. The top of the bedding further includes a plurality of holes such that the excreta from the pet can pass through the top layer and be absorbed by the Interior bedding.

Numerous advantages and features of the invention will become readily apparent from the following detailed description of the invention and the embodiments thereof, and from the accompanying drawings.

### BRIEF DESCRIPTION OF THE DRAWINGS

A fuller understanding of the foregoing may be had by reference to the accompanying drawings, wherein:

FIG. 1 is a top view Illustrating a pet bedding defined by one or more of the embodiments of the present invention.

### DETAILED DESCRIPTION OF THE EMBODIMENTS

While the invention Is susceptible to embodiments in many different forms, there are shown in the drawings and will described herein, in detail, the preferred embodiments of the present invention. It should be understood, however, that the present disclosure is to be considered an exemplification of the principles of the invention and Is not intended to limit the spirit or scope of the invention, claims and/or embodiments illustrated.

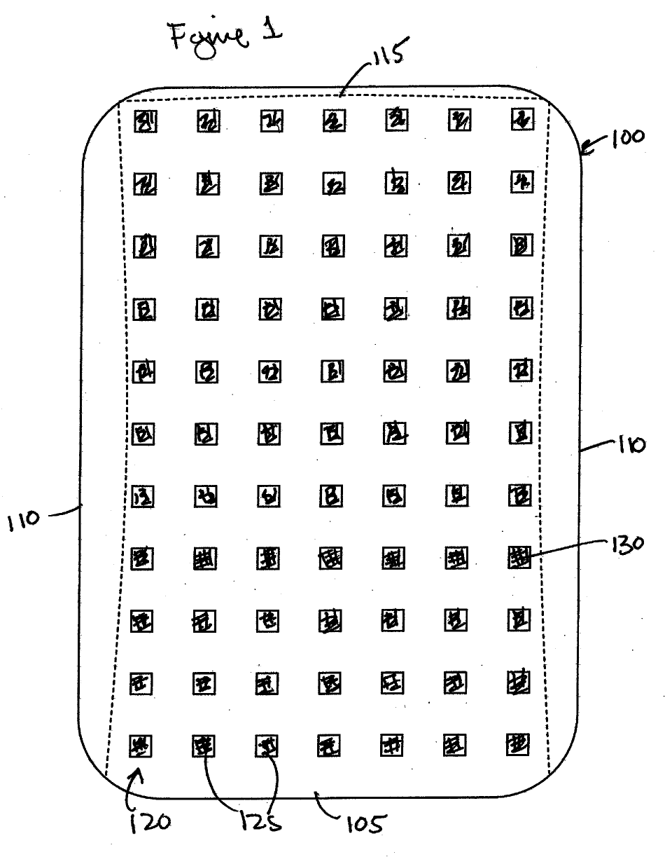

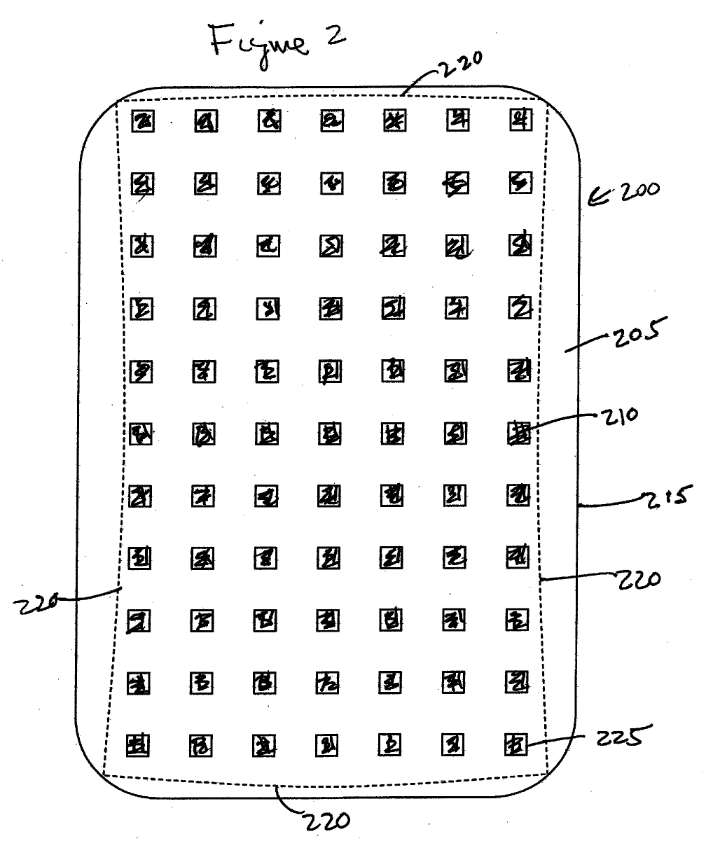

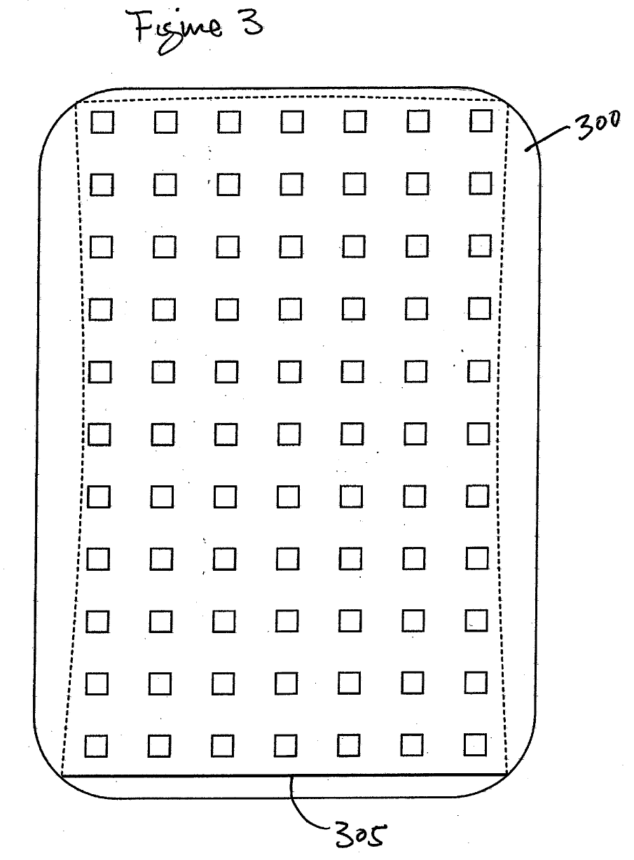

Referring now to FIG. 1, there is illustrated a pet bedding 100. The bedding 100 may be made with 100% cotton cloth and could cdme in a variety of sizes. Preferably, the bedding is made from a single sheet of material that has a first folded edge 105. The two side edges 110 can be stitched together to form an inside pocket for which the bedding material 130 can be stuffed. Preferably It Is stuffed with white 100% wood pulp to a thickness of about 1 inch. And then the edge 115 opposite the folded edge can be stitched together in order to seal the bedding inside the pocket. The top layer 120 of the bedding further includes a plurality of perforated holes 125 such that the excreta from the pet can pass through the top layer and be absorbed by the Interior bedding. For preferred embodiments the holes are square shaped having an opening of about ¼ to ½ inch,

In other embodiments, the pet bedding 200 (illustrated in FIG. 2) could comprise a cotton cloth top layer 205, a wood pulp 210 interior layer, and a cotton cloth bottom layer 215 sewn together with cotton thread around the edges 220 of the material. The top layer 205 is perforated with holes 225 placed about 2 inches apart. This pet bedding can also be produced to fit pre-manufactured cages of varying dimensions. The entire product Is then sewn shut. This product is made specifically for cages of these dimensions

In yet other embodiments, referring to FIG. 3, one side of the pet bedding 300 could be created with an resealable edge 305, such as with a zipper or Velcro to allow the absorbent material to be removed, the cloth could then be washed and dried and then filled with new material.

From the foregoing and as mentioned above, it Will be observed that numerous variations and modifications may be effected without departing from the spirit and scope of the novel concept of the invention. It Is to be understood that no limitation with respect to the specific methods and apparatus illustrated herein is intended or should be inferred. It is, of course, intended to cover all such modifications

We claim:

1. A pet bedding comprising:
a cloth top layer and a cloth bottom layer being stitched around the perimeter thereof;
an absorbent material being placed between the top and bottom layers; and
a plurality of holes In the top layer such that excreta can pass through the top layer and be absorbed by the absorbent material.

2. The pet bedding of claim 1I wherein the absorbent material is a white wood pulp.

3. The pet bedding of claim 1, wherein each hole, of the plurality of holes, have an opening length of about ¼ to about ½ inch.

4. The pet bedding of claim 3, wherein the plurality of holes are spaced about 2 inches apart.

5. A pet bedding comprising:
a piece of cloth material being folded to define a top layer and a bottom layer aligned one on top of each other, the folded material further defining a folded edge, two side edges, and an opened edge opposite the folded edge, the two side edges being stitched to create an interior pocket, an absorbent material being placed within the interior pocket, and the opened edge being further stitched such that the absorbent material is contained therein, and a plurality of openings positioned on the top layer such that excreta can pass through the top layer and be absorbed by the absorbent material.

6. The pet bedding of claim 5, wherein the absorbent material is a white wood pulp.

7. The pet bedding of claim 5, wherein each hole, of the plurality of holes, have an opening length of about ¼ to about ½ inch.

8. The pet bedding of claim 7, wherein the plurality of holes are spaced about 2 inches apart.

9. A pet bedding comprising:
a cloth top layer and a cloth bottom layer being stitched about one edge and two sides defined thereof;
an absorbent material being placed between the top and bottom layers;
a resealable edge placed about an edge opposite the stitched edge; and
a plurality of holes in the top layer such that excreta can pass through the top layer and be absorbed by the absorbent material.

10. The pet bedding of claim 9, wherein the absorbent material is a white wood pulp.

11. The pet bedding of claim 9, wherein each hole, of the plurality of holes, have an opening length of about ¼ to about ½ inch.

12. The pet bedding of claim 11, wherein the plurality of holes are spaced about 2 inches apart.
